(19) United States
(12) Patent Application Publication
(10) Pub. No.: US 2012/0148449 A1
(43) Pub. Date: Jun. 14, 2012

(54) ELECTRIC CONDUCTIVITY-BASED BIOSENSOR

(76) Inventors: Ya-Hsuan Chuang, Hsinchu City (TW); Kuo-Liang Liu, Hsinchu City (TW); Tri-Rung Yew, Hsinchu (TW)

(21) Appl. No.: 13/114,717

(22) Filed: May 24, 2011

(30) Foreign Application Priority Data
Dec. 13, 2010 (TW) 099143493

(51) Int. Cl. G01N 27/00

(52) U.S. Cl. 422/82.02

(57) ABSTRACT

An electric conductivity-based biosensor electrochemically detects the concentration of tested objects via measuring impedance or capacitance variation of the tested objects. The biosensor comprises a substrate, two electric-conduction electrodes arranged on the substrate, an antibody adhesion layer arranged on a region of the substrate and a plurality of antibodies arranged on the antibody adhesion layer. The antibody adhesion layer is between the two electric-conduction electrodes. The antibodies are connected with a plurality of tested objects. The tested objects connected with the antibodies form an electric-conduction group contacting the two electric-conduction electrodes. The concentration of the tested objects can be provided via measuring impedance or capacitance between the two electric-conduction electrodes.

### FIELD OF THE INVENTION

The present invention relates to a biosensor, particularly to an electric conductivity-based biosensor.

### BACKGROUND OF THE INVENTION

Biosensors can effectively quantify results of physical examination and provide exact values for health evaluation. A biosensor integrates a biological recognition element and a transduction element to convert biological signals into quantifiable electronic signals. Biosensors may be categorized into bioaffmity sensors and biocatalytic sensors according to the types of biological recognition elements. Biosensors may be categorized into electrochemical type, optical type, piezoelectric type, FET (Field Effect Transistor) and OTFT (Organic Thin Film Transistor) biosensors according to the types of transduction elements.

A U.S. Pat. No. 7,485,453, disclosed “Diffraction-Based Diagnostic Devices”, wherein the concentration of a tested enzyme is detected with an optical method. However, the diffraction apparatus have complicated structure and expensive cost. Further, optical examination demands higher environmental restrictions. The examination results would be affected if the environment does not meet the requirements. For other types of transduction elements, high sensitivity compromises inexpensiveness and simplicity. A high-sensitivity biosensor is neither simple-structured nor low-priced. On the other hand, a simple-structured and low-priced biosensor should have low sensitivity.

### SUMMARY OF THE INVENTION

The primary objective of the present invention is to solve the problems of high cost and high environmental demand in the conventional biosensor technology.

Another objective of the present invention is to solve the problem of low sensitivity in the conventional biosensor technology.

To achieve the abovementioned objectives, the present invention proposes an electric conductivity-based biosensor, which comprises a substrate, two electric-conduction electrodes, an antibody adhesion layer and a plurality of antibodies. The two electric-conduction electrodes are arranged on the substrate. The antibody adhesion layer is arranged on a region of the substrate, which is between the two electric-conduction electrodes. The antibody adhesion layer includes a first surface contacting the substrate and a second surface opposite to the first surface. The plurality of antibodies is arranged on the second surface of the antibody adhesion layer. A plurality of tested objects is connected with the antibodies to form an electric-conduction group between the two electric-conduction electrodes. The antibody adhesion layer enhances adhesion between the antibodies and the substrate, whereby the antibodies are firmly secured to the substrate and positioned between the two electric-conduction electrodes.

In the present invention, the tested objects are connected with the antibodies to form an electric-conduction group contacting the two electric-conduction electrodes. The concentration of the tested objects is obtained via measuring the impedance or capacitance between the two electric-conduction electrodes. Thereby, the electric conductivity-based biosensor of the present invention can obtain the quantitative and accurate data of the test results. In addition, the biosensor can undertake tests in a dry environment. Thus, the present invention does not restrict by the environmental requirement. Further, the biosensor can be fabricated with a photolithographic technology and an etching technology. Therefore, the biosensor of the present invention has features including simplified structure, easy fabrication and low price.

### BRIEF DESCRIPTION OF THE DRAWINGS

FIGS. 1A to 1E show a series of cross-sectional views for the process of fabricating an electric conductivity-based biosensor according to one embodiment of the present invention; and

FIG. 2 shows a diagram of an HSA concentration-impedance relationship according to one embodiment of the present invention.

### DETAILED DESCRIPTION OF THE PREFERRED EMBODIMENTS

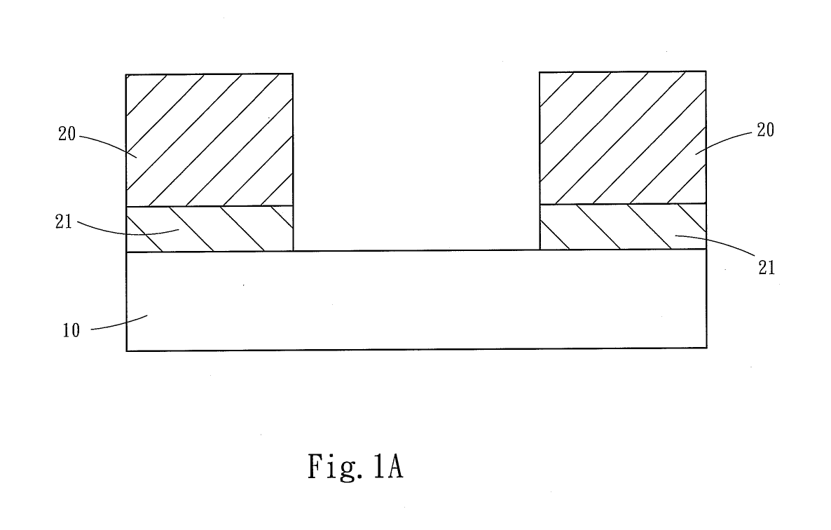

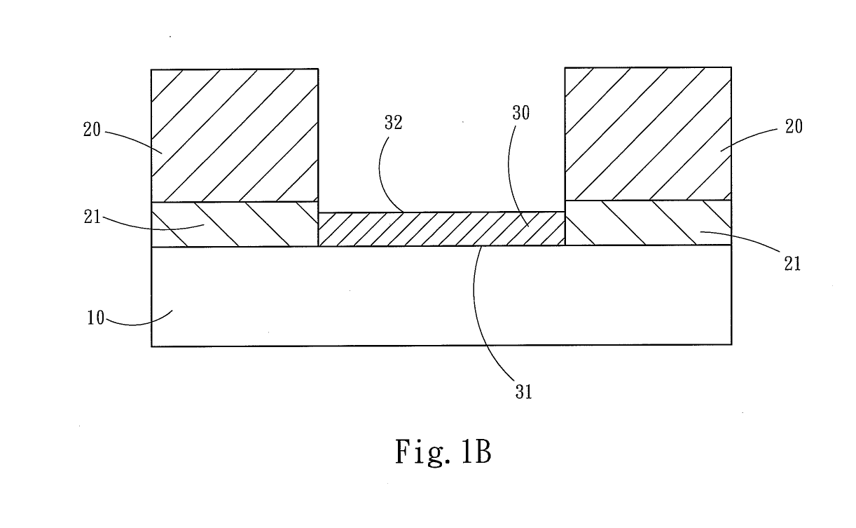

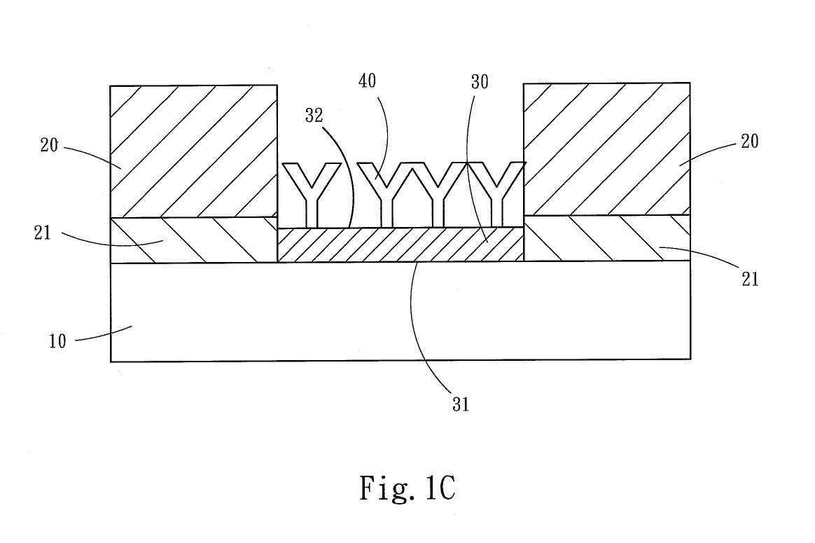

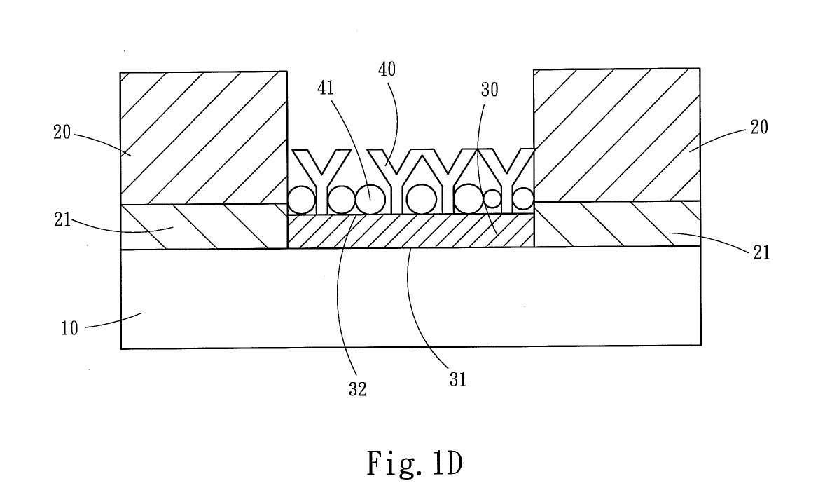

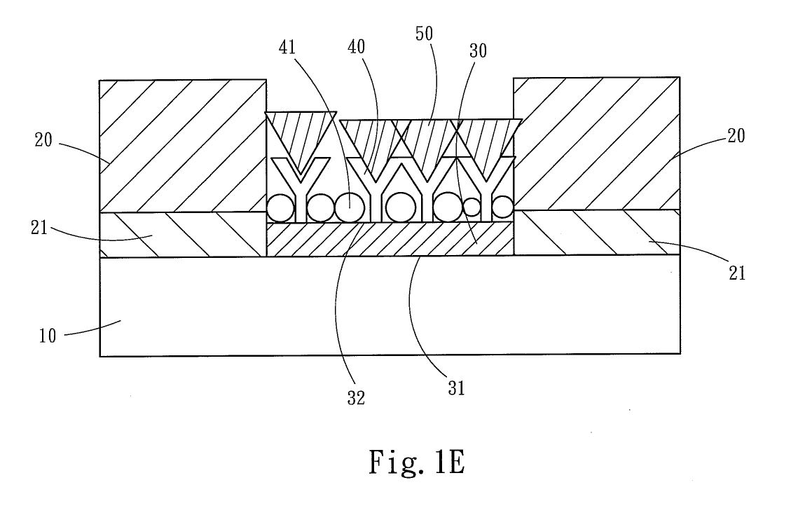

The technical contents of the present invention are described in detail in cooperation with the drawings below. Refer to FIGS. 1A to 1E for a series of cross-sectional views showing the process of fabricating an electric conductivity-based biosensor according to one embodiment of the present invention. The biosensor of the present invention comprises a substrate 10, two electric-conduction electrodes 20, an antibody adhesion layer 30 and a plurality of antibodies 40. The two electric-conduction electrodes 20 are separately arranged on the substrate 10. The antibody adhesion layer 30 is arranged on a region of the substrate 10, which is between the two electric-conduction electrodes 20. The antibody adhesion layer 30 includes a first surface 31 contacting the substrate 10 and a second surface 32 opposite to the first surface 31. The plurality of antibodies 40 is arranged on the second surface 32 of the antibody adhesion layer 30 and connected with a plurality of tested objects 50. The antibody adhesion layer 30 enhances adhesion between the antibodies 40 and the substrate 10, whereby the antibodies 40 are firmly secured to the substrate 10 and positioned between the two electric-conduction electrodes 20.

In one embodiment of the present invention, a photolithographic technology and an etching technology are used to fabricate the two electric-conduction electrodes 20 on the substrate 10. The substrate 10 is a glass substrate or a silicon substrate covered by an insulating layer. The two electric-conduction electrodes 20 are connected to the substrate 10 via two auxiliary connection layers 21. The auxiliary connection layer 21 enhances connection between the electric-conduction electrode 20 and the substrate 10. The two electric-conduction electrodes 20 are made of gold, aluminum, platinum, or a combination thereof. The two auxiliary connection layers 21 are made of chromium or titanium. Next, the antibody adhesion layer 30 is arranged between the two electric-conduction electrodes 20 and stuck to the surface of the substrate 10. In one embodiment, the antibody adhesion layer 30 is made of APTES (3-Aminopropyltriethoxysilane). The antibody adhesion layer 30 is installed on the substrate 10 with a molecular self-assembly technology.

Next, a plurality of antibodies 40 is arranged on the antibody adhesion layer 30. The antibodies 40 cannot directly adhere to the substrate 10 but can indirectly adhere to the substrate 10 via the antibody adhesion layer 30. Due to the specificity of the antibodies 40, the antibodies 40 only bind the molecules of the specified tested object 50. In one embodiment, the plurality of antibodies 40 is AHSA (Anti-Human Serum Albumin), which specifically binds HSA (Human Serum Albumin) in the tested objects 50. HSA is an indicator of the liver function of human beings. Different inspections can be implemented by different types of antibodies 40.

After the antibodies 40 have been disposed, a plurality of retard particles 41 is disposed on the second surface 32 of the antibody adhesion layer 30 and cover an area which the connected antibodies 40 do not cover. Thereby, the antibody adhesion layer 30 is isolated from external environment. In one embodiment, the retard particles 41 are made of bovine serum albumin or gelatin.

In test, the tested objects 50 that contain HSA connecting with the antibodies 40 form an electric-conduction group. The HSA concentration in the tested objects 40 is learned via measuring the impedance or capacitance between the two electric-conduction electrodes 20. The tested objects 50 adhering to the antibody adhesion layer 30 affect the electric properties of the electric-conduction group between the two electric-conduction electrodes 20. The retard particles 41 prevent the tested objects 50 from contacting the antibody adhesion layer 30. Thereby, neither the electric properties of the electric-conduction group nor and the measurement results thereof are affected.

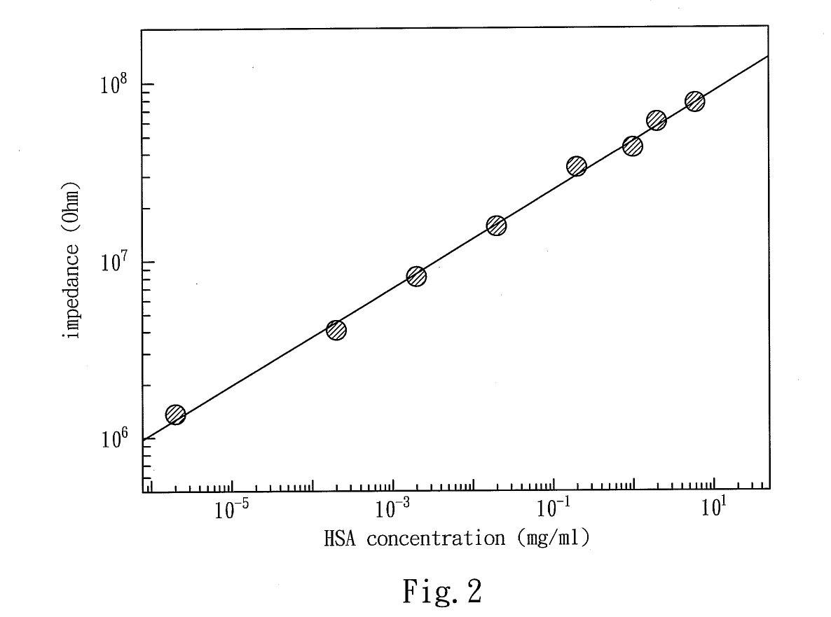

Refer to FIG. 2 for a diagram of an HSA concentration-impedance relationship according to one embodiment of the present invention. In order to establish an HSA concentration-impedance relationship, HSA concentrations of a group of HSA-containing samples are detected firstly. Then, the impedance or capacitance of each sample between the two electric-conduction electrodes 20 is measured. In one embodiment, an alternating current with a frequency of 20 Hz-100 kHz is applied to the two electric-conduction electrodes 20 for electric measurements, and a frequency of 100 kHz is preferred. When a 100 kHz alternating current is adopted, the measured values are more correct, the measurement quality is more stable. From FIG. 2, it is known that impedance increases linearly with HSA concentration, plotting in log-scale. Thereby, when a sample containing an unknown concentration of HSA is tested, the measured impedance can be converted into the HSA concentration of the sample according to the linear relationship.

In the electric conductivity-based biosensor of the present invention, the tested objects 50 bound on the antibodies 40 form an electric-conduction group contacting the two electric-conduction electrodes 20. The concentration of the tested objects 50 is obtained via measuring impedance or capacitance between the two electric-conduction electrodes 20. The present invention can undertake tests in a dry environment. Thus, the present invention does not limit by high environmental requirements. Further, the present invention can be fabricated with a photolithographic method and an etching method, so as to be easy to fabricate and has advantages of simple structure and low cost. Furthermore, the retard particles 41 isolate the antibody adhesion layer 30 from external environment and prevent the tested objects 50 from contacting the antibody adhesion layer 30. Thus is avoided the electric measurement error caused by the tested objects 50 adhering to the antibody adhesion layer 30.

The above description has proved that the present invention possesses utility, novelty and non-obviousness and meets the condition for a patent. Thus, the Inventor files the application for a patent. It is appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. An electric conductivity-based biosensor comprising
a substrate;
two electric-conduction electrodes arranged on the substrate;
an antibody adhesion layer arranged on a region of the substrate, which is between the two electric-conduction electrodes, the antibody adhesion layer including a first surface contacting the substrate and a second surface opposite to the first surface; and
a plurality of antibodies arranged on the second surface of the antibody adhesion layer and connected with a plurality of tested objects, wherein the antibody adhesion layer enhances adhesion between the antibodies and the substrate, and wherein the tested objects connected with the antibodies form an electric-conduction group contacting the two electric-conduction electrodes.

2. The electric conductivity-based biosensor according to claim 1, wherein the substrate is a glass substrate or a silicon substrate covered by an insulating layer.

3. The electric conductivity-based biosensor according to claim 1, wherein the two electric-conduction electrodes are made of a material selecting from a group consisting of gold, aluminum, platinum and a combination thereof.

4. The electric conductivity-based biosensor according to claim 1, wherein the two electric-conduction electrodes are respectively connected to the substrate via two auxiliary connection layers.

5. The electric conductivity-based biosensor according to claim 4, wherein the two auxiliary connection layers are made of a material selecting from a group consisting of chromium, titanium and a combination thereof.

6. The electric conductivity-based biosensor according to claim 1, wherein the antibody adhesion layer is made of 3-Aminopropyltriethoxysilane.

7. The electric conductivity-based biosensor according to claim 6, wherein the plurality of antibodies is Anti-Human Serum Albumin, which connects specifically with Human Serum Albumin in the tested objects.

8. The electric conductivity-based biosensor according to claim 1, wherein a plurality of retard particles is disposed on the second surface of the antibody adhesion layer to cover an area which is not covered by the connected antibodies.

9. The electric conductivity-based biosensor according to claim 8, wherein the retard particles are made of bovine serum albumin or gelatin.

10. The electric conductivity-based biosensor according to claim 1, wherein the two electric-conduction electrodes is connected with an alternating current with a frequency of 20 Hz-100 kHz.
